(19) United States
(12) Patent Application Publication
(10) Pub. No.: US 2014/0000561 A1
(43) Pub. Date: Jan. 2, 2014

(54) HYDRAULIC SEAL WITH A DYNAMIC CLEARANCE FOR A FUEL INJECTOR

(71) Applicant: Jian Ye, Naperville, IL (US)

(72) Inventor: Jian Ye, Naperville, IL (US)

(73) Assignee: International Engine Intellectual Property Company, LLC, Lisle, IL (US)

(21) Appl. No.: 14/005,262

(22) PCT Filed: Mar. 18, 2011
(86) PCT No.: PCT/US11/28955

§ 371 Date: Sep. 14, 2013

(51) Int. Cl. F02M 67/00

(52) U.S. Cl. CPC F02M 67/00
USPC 123/445

(57) ABSTRACT

A hydraulically intensified fuel injection system comprises a hydraulic fluid accumulator, an adapter, and an injector connecting tube. The hydraulic fluid accumulator has a fluid outlet and is adapted to contain a volume of pressurized hydraulic fluid. The adapter is disposed partially within the fluid outlet of the hydraulic fluid accumulator. The adapter has an first opening provided in fluid communication with the fluid outlet of the hydraulic fluid accumulator. The first opening of the adapter has a recessed groove. The injector connecting tube is disposed at least partially within the first opening of the adapter. The injector connecting tube has an upper portion and a lower portion. The upper portion is adapted to deflect outward to reduce a gap between the injector connecting tube and the first opening of the adapter. The injector connecting tube has an second opening formed through the upper portion and the lower portion.

### TECHNICAL FIELD

The present disclosure relates to a hydraulic seal having a dynamic clearance for use with a fuel injector. More particularly, the disclosure relates to a hydraulic seal for a fuel injector used in a hydraulically intensified fuel injection system.

### BACKGROUND

Fuel systems for modern diesel engines operate at ever increasing fuel injection pressures. One way to achieve these high fuel injection pressures is to utilize a hydraulically intensified fuel injection system. Such a system may utilize a high-pressure common rail system that provides fuel to each individual injector from a high-pressure accumulator, oftentimes referred to as the “rail” or “common rail.” The injector also receives a high-pressure hydraulic fluid, such as engine oil, that is utilized to drive a piston, or other pressure intensifying system, to increase the pressure of the fuel that leaves the injector to the pressures required by modern diesel engines. The delivery of high-pressure hydraulic fluid to the fuel injector to may also be provided from a hydraulic fluid accumulator sometimes called an “oil-rail.” FIG. 1 shows an existing oil-rail and fuel injector connection 10. A first seal 12 having a generally D-shape, and a backup ring 14 seal hydraulic fluid flow between an injector connector tube 16 and an injector 18. The hydraulic fluid flowing between the injector connector tube 16 and the injector 18 may be at a pressure up to 40 MPa. In order for the first seal 12 to be able to withstand such pressures and stay properly positioned, the groove 20 where the first seal 12 resides needs to have a very tight tolerance, and a clearance of about 0.0445 mm relative to the first seal 12. Unfortunately, manufacturing limitations often allow the clearance between the groove 20 and the first seal 12 to be as large as 0.065 mm When the clearance is above 0.0445 mm, the first seal may be displaced by the pressure of the hydraulic fluid, and the hydraulic fluid may leak. To combat this leakage, the thickness of the second seal 14 has been increased, but the failure rate of the first seal 12 continues to be unacceptable. Therefore a need exists for a way to connect a hydraulic fluid accumulator to an injector while maintaining a proper fluid seal.

### SUMMARY

According to one embodiment, a hydraulically intensified fuel injection system comprises a hydraulic fluid accumulator, an adapter, and an injector connecting tube. The hydraulic fluid accumulator has a fluid outlet and is adapted to contain a volume of hydraulic fluid at a pressure from about 30 MPa to about 50 MPa. The adapter is disposed at least partially within the fluid outlet of the hydraulic fluid accumulator. The adapter has a first opening provided in fluid communication with the fluid outlet of the hydraulic fluid accumulator. The first opening of the adapter has a recessed groove. The injector connecting tube is disposed at least partially within the first opening of the adapter. The injector connecting tube has an upper portion and a lower portion. The upper portion is adapted to deflect outward to reduce a gap between the injector connecting tube and the first opening of the adapter. The injector connecting tube has an second opening formed through the upper portion and the lower portion.

According to another embodiment, an injector connecting tube for use with a hydraulically intensified fuel injection system comprises an upper portion, a lower portion, and an opening formed through the upper portion and the lower portion. The upper portion has a first outer diameter. The lower portion has a second outer diameter. The opening has a first inner diameter in a portion of the opening formed through the upper portion. The opening has a second inner diameter in a portion of the opening formed through the lower portion. The opening is adapted to receive pressurized hydraulic fluid from a hydraulic fluid accumulator. A wall thickness between the outer diameter of the upper portion and the inner diameter of the opening formed through the upper portion is less than a wall thickness between the outer diameter of the lower portion and the inner diameter of the opening formed through the lower portion.

According to a further embodiment, an injector connecting tube for use with a hydraulically intensified fuel injection system comprises an upper portion, a lower portion, an intermediate portion, and an opening. The upper portion has a first outer diameter. The lower portion has a second outer diameter. The intermediate portion is disposed between the upper portion and the lower portion. The intermediate portion has a third outer diameter. The opening is formed through the upper portion, the lower portion and the intermediate portion. The opening has a first inner diameter in a portion of the opening formed through the upper portion, a second diameter in a portion of the opening formed through the lower portion, and the opening has a third inner diameter in a portion of the opening formed through the intermediate portion. The opening is adapted to receive pressurized hydraulic fluid from a hydraulic fluid accumulator. A wall thickness between the outer diameter of the intermediate portion and the third inner diameter of the opening formed through the intermediate portion is less than a wall thickness between the outer diameter of the lower portion and the first inner diameter of the opening formed through the lower portion and a wall thickness between the outer diameter of the upper portion and the second inner diameter of the opening formed through the upper portion.

### BRIEF DESCRIPTION OF THE DRAWINGS

FIG. 1 is a schematic view of a connection between a hydraulic accumulator and a fuel injector according to a prior art design.

FIG. 2 is a sectional schematic view of a hydraulic accumulator having a portion of a fuel injector connector connected thereto according to one embodiment.

FIG. 3 is a schematic view of an adapter and an injector connecting tube connected to a hydraulic accumulator according to the embodiment of FIG. 2.

FIG. 4 is a detailed view of a portion of FIG. 3;

FIG. 5 is a schematic view showing displacement of a portion of the injector connecting tube during fluid flow.

FIGS. 6A-6C are schematic views showing configurations of the injector connecting tube according to three embodiments.

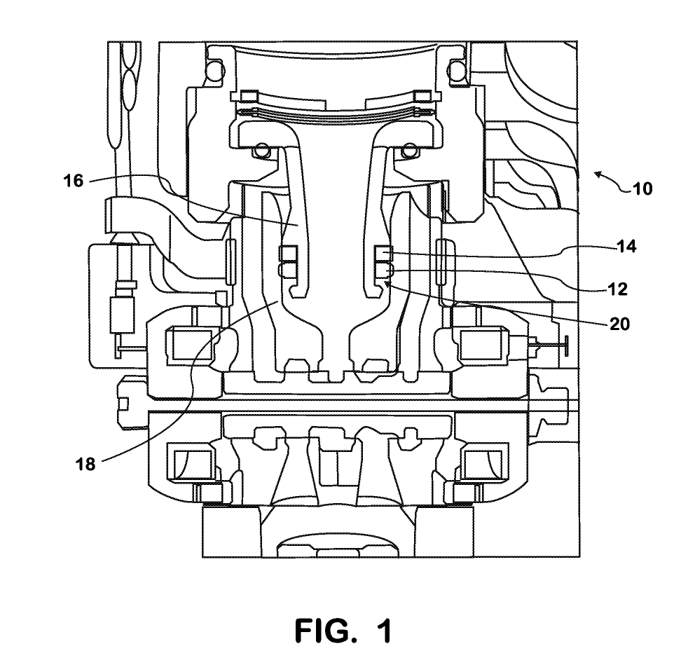

### DETAILED DESCRIPTION

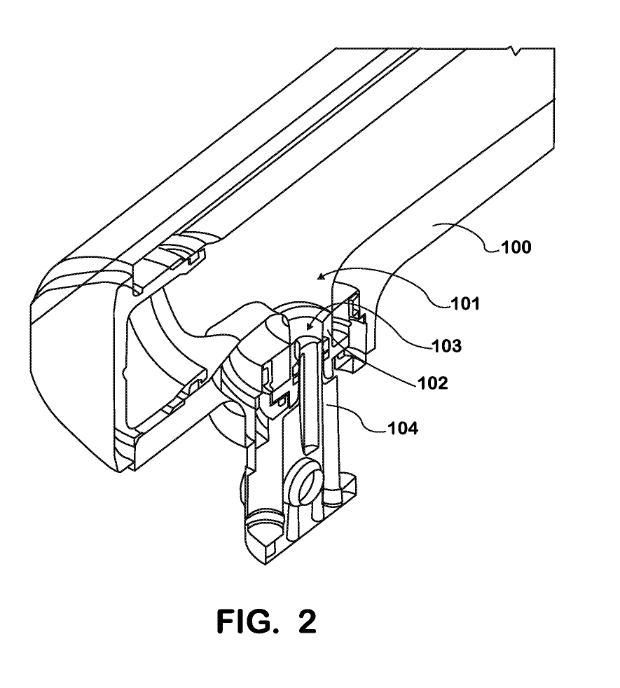

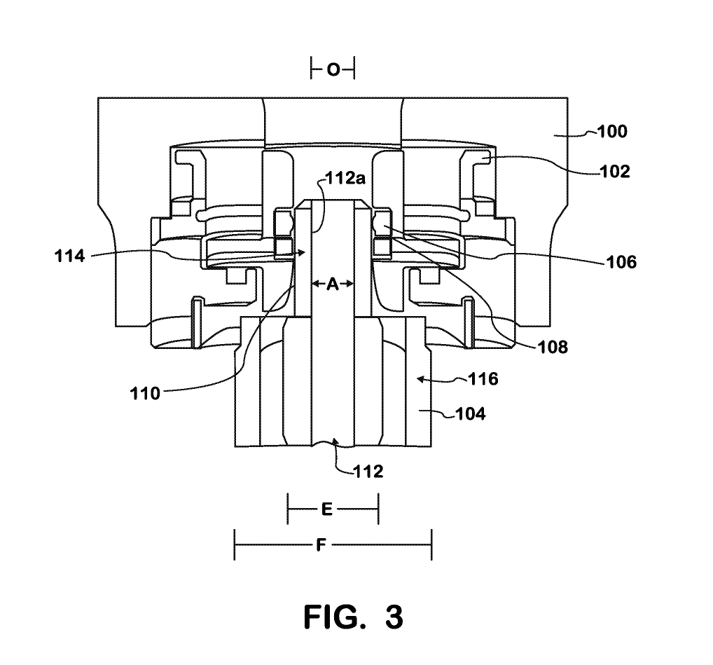

FIGS. 2 and 3 show a portion of a hydraulic accumulator 100 for a hydraulically intensified fuel injection system. The accumulator 100 contains a hydraulic fluid, such as engine lubricating oil, although it is contemplated that other fluids may be used. The hydraulic accumulator 100 has an outlet opening 101 for each cylinder of an engine that utilizes the accumulator 100. An adapter 102 is disposed within the outlet opening 101. The adapter 102 has an opening 103 that allows an injector connecting tube 104 to be provided in fluid communication with outlet opening 101 of the accumulator 100. The injector connecting tube 104 is disposed in fluid communication with the accumulator 100, and a fuel injector (not shown) of the engine. The injector connecting tube allows hydraulic fluid from the accumulator 100 to flow to the injector for use with the hydraulically intensified fuel injection system.

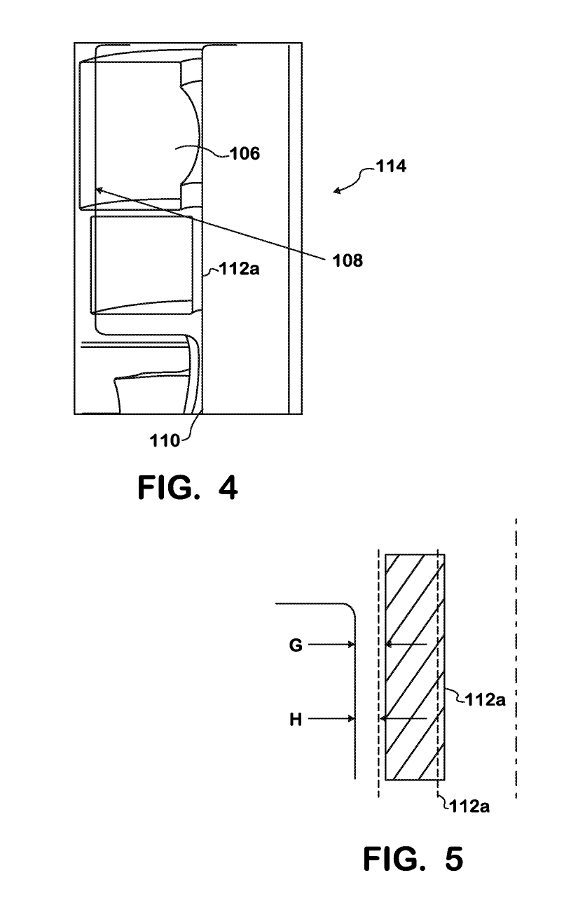

As shown more clearly in FIGS. 3 and 4, a seal 106 is disposed within a recessed groove 108 of the adapter 102. The seal 106 may be an O-ring type seal, or other known seal design. The seal 106 restricts the flow of hydraulic fluid down an outer periphery 110 of the injector connecting tube 104. The injector connecting tube 104 has a center opening 112 that is adapted to receive hydraulic fluid from the accumulator 100 and provide the hydraulic fluid to the injector. The injector connecting tube additionally comprises an upper portion 114, and a lower portion 116. The center opening 112 passes through both the upper portion 114 and the lower portion of the injector connecting tube 104. A generally horizontal shoulder surface 118 is provided at the transition between the upper portion 114 and the lower portion 116 of the injector connecting tube 104.

The hydraulic fluid within the hydraulic accumulator 100 that is provided to the injector connecting tube 104 is at a pressure from about 30 MPa to about 50 MPa, more specifically, a pressure of about 40 MPa is present within the accumulator 100. The center opening 112 has a diameter D. The upper portion 114 of the injector connecting tube 104 has an outer diameter E, which is greater than the diameter D of the center opening 112. The lower portion 116 of the injector connecting tube 104 has an outer diameter F, which is greater than the diameter D of the upper portion 114 of the injector connecting tube 104.

Hydraulic fluid passing through the center opening 112 of the injector connecting tube 104 at a pressure of between about 30 MPa and 50 MPa exerts a substantial radial force A on a sidewall 112a of the center opening 112. The radial force A causes displacement of the outer periphery 110 of the upper portion 114 of the injector connecting tube 104. This displacement of the outer periphery 110 decreases a distance between the seal 106 and the injector connecting tube 104, thereby enhancing the fluid flow restriction properties of the seal 106. Additionally, the outer periphery 110 moves closer to the adapter 102, further restricting the flow of any hydraulic fluid that may leak past the seal 106 at locations downstream of the hydraulic fluid flowing direction.

The upper portion 114 of the injector connecting tube 104 thus has a thinner wall than the lower portion 116 of the injector connecting tube 104. This thinner wall of the upper portion causes the upper portion to deform based on the pressure of the hydraulic fluid passing through the center opening 112, thereby increasing the outer diameter E, and reducing a gap between the injector connecting tube 104 and the adapter 102. This increases the effectiveness of the seal 106 to resist hydraulic fluid passing between the injector connecting tube 104 and the adapter 102.

FIG. 5 shows the displacement of the upper portion 114 of the injector connecting tube 104 in from a distance G between the upper portion 114 of the injector connecting tube 104 and the adapter 102 when no fluid is passing through the injector connecting tube 104, to a distance H (shown in broken lines) between the upper portion 114 of the injector connecting tube 104 and the adapter 102 when hydraulic fluid at a pressure between about 30 MPa and about 50 MPa is passing through the injector connecting tube 104. The distance H is less than the distance G, thereby improving the seal formed between the injector connecting tube 104 and the adapter 102.

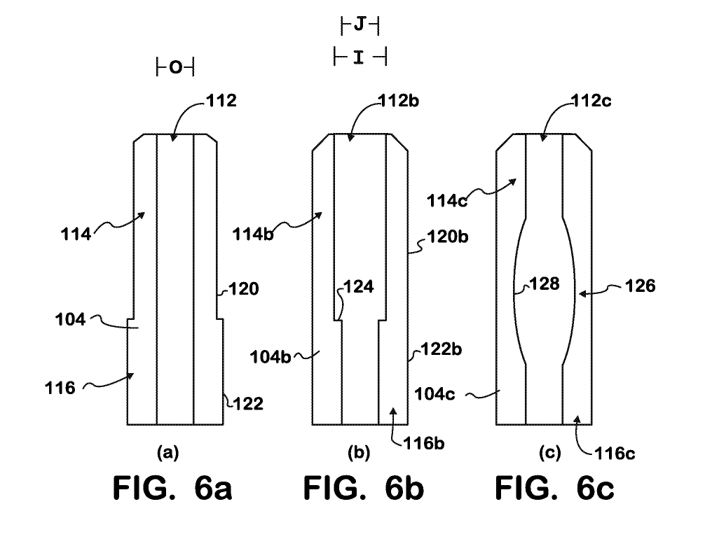

FIG. 6A-FIG. 6C show three alternative geometries that may be utilized in the upper portion 114 of the injector connecting tube 104. As shown in FIG. 6A, the upper portion 114 of the injector connecting tube 104 has a smaller outer diameter 120 than an outer diameter 122 of the lower portion 116. Thus, the center opening 112 maintains a generally constant diameter D throughout.

FIG. 6B shows an upper portion 114b of an injector connecting tube 104b that has a generally equal outer diameter 120b as an outer diameter 122b of a lower portion 116b of the injector connecting tube 104b. Instead the center opening 112b of the injector connecting tube 104b has shoulder 124 at a transition from the upper portion 114b to the lower portion 116b. The center opening 112b therefore has a first diameter I in the upper portion 114b, and a second diameter J in the lower portion 116b. The first diameter I is larger than the second diameter J, thus a wall thickness of the upper portion 114b is less than the lower portion 116b, allowing the pressure of hydraulic fluid flowing through the center opening 112b to displace the upper portion 114b outward, reducing the distance between the injector connecting tube 104b and the adapter 102.

Finally, FIG. 6c shows an injector connecting tube 104c. The injector connecting tube 104c has an upper portion 114c, a lower portion 116c and a middle portion 126. The middle portion 126 is disposed between the upper portion 114c and the lower portion 116c. The middle portion 126 forms a semi-circular recess 128 that reduces a wall thickness of the middle portion 126 relative to the upper portion 114c and the lower portion 116c. The semi-circular recess 128 thus increases the diameter of the center opening 112c in the middle portion 126, thereby reducing a wall thickness of the middle portion 126 of the injector connecting tube 104c. Thus, the pressure of hydraulic fluid flowing through the center opening 112c displaces the middle portion 126 outward, reducing the distance between the injector connecting tube 104c and the adapter 102.

Thus, the injector connecting tubes 104, 104b, 104c provide a region where hydraulic fluid flowing through a center opening 112, 112b, 112c displaces a portion of an outer wall of the injector connecting tube outward, reducing the gap between the injector connecting tubes 104, 104b, 104c and an adapter 102, thereby reducing the likelihood of fluid leaking between the injector connecting tube 104, 104b, 104c and the adapter.

What is claimed is:

1. A hydraulically intensified fuel injection system comprising:
a hydraulic fluid accumulator having a fluid outlet, and being adapted to contain a volume of hydraulic fluid at a pressure from about 30 MPa to about 50 MPa;
an adapter disposed at least partially within the fluid outlet of the hydraulic fluid accumulator, the adapter having a first opening provided in fluid communication with the fluid outlet of the hydraulic fluid accumulator, the first opening of the adapter having a recessed groove;
an injector connecting tube disposed at least partially within the first opening of the adapter, the injector connecting tube having an upper portion and a lower portion, the upper portion adapted to deflect outward reducing a gap between the injector connecting tube and the first opening of the adapter, the injector connecting tube having a second opening formed through the upper portion and the lower portion.

2. The hydraulically intensified fuel injection system of claim 1, further comprising a seal, the seal being disposed in the recessed groove of the adapter.

3. The hydraulically intensified fuel injection system of claim 2, wherein the seal is an O-ring.

4. The hydraulically intensified fuel injection system of claim 2, wherein the seal contacts an outer surface of the injector connecting tube.

5. The hydraulically intensified fuel injection system of claim 2, wherein the seal contacts an outer surface of the upper portion of injector connecting tube.

6. The hydraulically intensified fuel injection system of claim 1, wherein the upper portion of the injector connecting tube has a thinner wall thickness than the lower portion of the injector connecting tube.

7. The hydraulically intensified fuel injection system of claim 6, wherein an outer diameter of the upper portion of the injector connecting tube is less than an outer diameter of the lower portion of the injector connecting tube.

8. The hydraulically intensified fuel injection system of claim 6, wherein an inner diameter of the opening of the upper portion of the injector connecting tube is more than an inner diameter of the opening of the lower portion of the injector connecting tube.

9. An injector connecting tube for use with a hydraulically intensified fuel injection system comprising:
an upper portion having a first outer diameter;
a lower portion having a second outer diameter; and
an opening formed through the upper portion and the lower portion, the opening having a first inner diameter in a portion of the opening formed through the upper portion, and the opening having a second inner diameter in a portion of the opening formed through the lower portion, the opening adapted to receive pressurized hydraulic fluid from a hydraulic fluid accumulator, wherein a wall thickness between the outer diameter of the upper portion and the inner diameter of the opening formed through the upper portion is less than a wall thickness between the outer diameter of the lower portion and the inner diameter of the opening formed through the lower portion.

10. The injector connecting tube of claim 9, wherein the first inner diameter is larger than the second inner diameter.

11. The injector connecting tube of claim 10, wherein the first outer diameter is generally equal to the second outer diameter.

12. The injector connecting tube of claim 9, wherein the first outer diameter is smaller than the second outer diameter.

13. The injector connecting tube of claim 12, wherein the first inner diameter is generally equal to the second inner diameter.

14. The injector connecting tube of claim 9, wherein the first outer diameter is smaller than the second outer diameter, and the first inner diameter is larger than the second inner diameter.

15. The injector connecting tube of claim 9, wherein the upper portion is adapted to contact a seal within the hydraulically intensified fuel injection system.

16. An injector connecting tube for use with a hydraulically intensified fuel injection system comprising:
an upper portion having a first outer diameter;
a lower portion having a second outer diameter;
an intermediate portion disposed between the upper portion and the lower portion, the intermediate portion having a third outer diameter; and
an opening formed through the upper portion, the lower portion and the intermediate portion, the opening having a first inner diameter in a portion of the opening formed through the upper portion, a second diameter in a portion of the opening formed through the lower portion, and the opening having a third inner diameter in a portion of the opening formed through the intermediate portion, the opening adapted to receive pressurized hydraulic fluid from a hydraulic fluid accumulator, wherein a wall thickness between the outer diameter of the intermediate portion and the third inner diameter of the opening formed through the intermediate portion is less than a wall thickness between the outer diameter of the lower portion and the first inner diameter of the opening formed through the lower portion and a wall thickness between the outer diameter of the upper portion and the second inner diameter of the opening formed through the upper portion.

17. The injector connecting tube of claim 15, wherein the intermediate portion has a semi-circular cross-sectional shape between the upper portion and the lower portion.

18. The injector connecting tube of claim 15, wherein the first outer diameter, the second outer diameter, and the third outer diameter are generally equal.

19. The injector connecting tube of claim 15, wherein the first inner diameter and the second inner diameter are generally equal.

20. The injector connecting tube of claim 15, wherein the intermediate portion is adapted to contact a seal within the hydraulically intensified fuel injection system.
